(19) United States
(12) Patent Application Publication
(10) Pub. No.: US 2026/0156179 A1
(43) Pub. Date: Jun. 4, 2026

(54) SIMULTANEOUSLY EXECUTING A PLURALITY OF REMOTE DIRECT MEMORY ACCESS (RDMA) PROTOCOLS OVER THE SAME PORT OF A NETWORK INTERFACE CONTROLLER (NIC)

(71) Applicant: Chelsio Communications, Inc., Sunnyvale, CA (US)

(72) Inventor: Bharat Teja Potnuri, Bengaluru (IN)

(73) Assignee: Chelsio Communications, Inc., Sunnyvale, CA (US)

(21) Appl. No.: 18/969,023

(22) Filed: Dec. 4, 2024

(51) Int. Cl. H04L 67/1097

(52) U.S. Cl. CPC H04L 67/1097

(57) ABSTRACT

A system for communicating over a physical port includes a Remote Direct Memory Access (RDMA) capable network adapter, a host computing device communicatively coupled to the RDMA capable network adapter, a physical port associated with the host computing device, and a plurality of interfaces associated with the physical port, the plurality of interfaces having different RDMA protocols.

### TECHNICAL FIELD

The present disclosure relates generally to computer networking and communications. Specifically, the present disclosure relates to systems and methods for supporting remote direct memory access (RDMA) protocols including, for example, internet wide area RDMA protocol (iWARP) and RDMA over converged ethernet version 2 (RoCEv2) protocol over a single physical port of a network adapter.

### BACKGROUND

Computing devices within a computing network ubiquitously send and receive data between one another for a myriad of reasons. These computing devices may each include network interface controllers (NICs) (also referred to as network adapters) that include any computer hardware and/or software components that connect the computing devices to the network and one another. A NIC may utilize one or more protocols and standards that allow the NIC to interface with, for example, hardware within the computing device.

As a specific type of NIC, remote direct memory access (RDMA) network interface controllers (RNICs) may allow applications to communicate with hardware directly from an application address space. The RDMA architecture is designed to provide an abstraction between RDMA interfaces and the underlying network technology (e.g., Ethernet and InfiniBand). The RDMA may expose a consistent interface to applications in a network-technology agnostic manner in order to enable the same application to implement RDMA on any network technology that supports RDMA.

RDMA is an extension of direct memory access (DMA) technology, which allows for direct access to host memory without CPU intervention. RDMA's efficiency comes from bypassing the traditional network stack, which allows data to be transferred directly from one computer's memory to another over the network with minimal CPU intervention. This direct transfer path may significantly reduce latency and increase data transfer speeds, making RDMA ideal for distributed computing scenarios where performance and efficiency are important.

An RNIC may include hardware capability to run both internet wide area RDMA protocol (iWARP) and RDMA over converged Ethernet version 2 (RoCEv2 ) protocol. However, an overlying RDMA software stack may not allow for both iWARP and RoCEv2 protocol as each interface and associated protocols require registration with an RDMA software stack as either an iWARP capable device or an RoCEv2 protocol capable device, but not both. Similarly, an overlying RDMA application may not differentiate between iWARP and RoCEv2 as the application interface remains the same for all RDMA protocols. There are currently no mechanisms to provide a reliable way of running iWARP and RoCEv2 protocol concurrently over the same port of an RNIC even in instances where the hardware of the computing device supports both iWARP and RoCEv2.

### BRIEF DESCRIPTION OF THE DRAWINGS

The detailed description is set forth below with reference to the accompanying figures. In the figures, the left-most digit(s) of a reference number identifies the figure in which the reference number first appears. The use of the same reference numbers in different figures indicates similar or identical items. The systems depicted in the accompanying figures are not to scale and components within the figures may be depicted not to scale with each other.

FIG. 1 illustrates communication hardware of a computing device including interfaces concurrently supporting different network protocols, according to an example of the principles described herein.

FIG. 2 illustrates a computer architecture diagram showing an illustrative computer hardware architecture for communicating over a physical port, according to an example of the principles described herein.

FIG. 3 illustrates a flow diagram of an example method for communicating over a physical port, according to an example of the principles described herein.

FIG. 4 illustrates a flow diagram of an example method for communicating over a physical port, according to an example of the principles described herein.

FIG. 5 illustrates a block diagram illustrating an example packet switching device, according to an example of the principles described herein.

FIG. 6 illustrates a block diagram illustrating certain components of an example node, according to an example of the principles described herein.

FIG. 7 illustrates a computing system diagram illustrating a configuration for a data center, according to an example of the principles described herein.

### DESCRIPTION OF EXAMPLE EMBODIMENTS

### Overview

This disclosure describes communicating over a physical port within a computing device. More specifically, this disclosure describes methods and systems for supporting concurrent internet wide area RDMA protocol (iWARP) and RDMA over converged Ethernet version 2 (RoCEv2) protocol over the same physical port of an RNIC. The methods include underlying interface capabilities of the remote direct memory access (RDMA) network interface controller (RNIC) to expose two independent network interfaces for each physical port of RNIC. Each of the exposed network interfaces may be used by an RNIC-specific device driver to register with the RDMA software stack as an iWARP-capable port and an RoCEv2-capable port, respectively.

Examples described herein provide a system for communicating over a physical port. The system may include a Remote Direct Memory Access (RDMA) capable network adapter, and a host computing device communicatively coupled to the RDMA capable network adapter. The system may further include a physical port associated with the host computing device, and a plurality of interfaces associated with the physical port, the plurality of interfaces having different RDMA protocols.

The plurality of interfaces appear to the host computing device as ethernet interfaces with unique medium access control (MAC) addresses and internet protocol (IP) addresses. The plurality of interfaces are individually configurable. The plurality of interfaces associated with the physical port are independent of each other. The different RDMA protocols comprise internet wide area RDMA protocol (iWARP) and RDMA over converged Ethernet version 2 (RoCEv2) protocol. The different RDMA protocols are executed concurrently over the physical port of the RDMA capable network adapter. The physical port comprises a plurality of physical ports.

Examples described herein also provide a non-transitory computer-readable medium storing instructions that, when executed, causes a processor to perform operations, including, with a Remote Direct Memory Access (RDMA) capable network adapter, creating a first interface associated with a physical port of a host computing device, and creating a second interface associated with the physical port of the host computing device, the second interface having a different RDMA protocol relative to the first interface.

The operations further include, with a driver of the RDMA capable network adapter, registering the physical port twice based on the first interface and the second interface. The different RDMA protocols of the first interface and the second interface comprise internet wide area RDMA protocol (iWARP) and RDMA over converged Ethernet version 2 (RoCEv2) protocol, respectively. The first interface and the second interface appear to a host computing device as ethernet interfaces with unique medium access control (MAC) addresses and internet protocol (IP) addresses. The first interface and the second interface are individually configurable. The first interface and the second interface are independent of each other. The different RDMA protocols are executed concurrently over the physical port of the RDMA capable network adapter. The physical port comprises a plurality of physical ports.

Examples described herein also provide a method of communicating over a physical port, including, with a Remote Direct Memory Access (RDMA) capable network adapter, creating a first interface associated with a physical port of a host computing device, and creating a second interface associated with the physical port of the host computing device, the second interface having a different RDMA protocol relative to the first interface.

The method may further include, with a driver of the RDMA capable network adapter, registering the physical port twice based on the first interface and the second interface. The different RDMA protocols of the first interface and the second interface comprise internet wide area RDMA protocol (iWARP) and RDMA over converged Ethernet version 2 (RoCEv2) protocol, respectively. Further, the first interface and the second interface appear to a host computing device as ethernet interfaces with unique medium access control (MAC) addresses and internet protocol (IP) addresses.

The first interface and the second interface are individually configurable. The first interface and the second interface are independent of each other. The different RDMA protocols are executed concurrently over the physical port of the RDMA capable network adapter.

Additionally, the techniques described in this disclosure may be performed as a method and/or by a system having non-transitory computer-readable media storing computer-executable instructions that, when executed by one or more processors, performs the techniques described above.

### EXAMPLE EMBODIMENTS

This disclosure describes techniques for supporting concurrent internet wide area RDMA protocol (iWARP) and RDMA over converged Ethernet version 2(RoCEv2) protocol over the same physical port of a NIC (e.g., a remote direct memory access (RDMA) network interface controller (RNIC)). As described herein, iWARP is a transmission control protocol (TCP)-based protocol. Further, RoCEv2 is a user datagram protocol (UDP)-based protocol. Stated another way, the transport layer of iWARP is TCP-based and the transport layer for RoCEv2 it is UDP-based. A TCP-based protocol may include any protocol that may be used to communicate between two computing devices over a computing network and which is defined by the Internet Engineering Task Force (IETF). A UDP-based protocol may include any connectionless protocol that does not establish a connection with a destination computing device before transferring data, is defined to make available a datagram mode of packet-switched computer communication in the environment of an interconnected set of computer networks, and assumes that the Internet Protocol (IP) is used as the underlying protocol.

Certain implementations and embodiments of the disclosure will now be described more fully below with reference to the accompanying figures, in which various aspects are shown. However, the various aspects may be implemented in many different forms and should not be construed as limited to the implementations set forth herein. The disclosure encompasses variations of the embodiments, as described herein. Like numbers refer to like elements throughout.

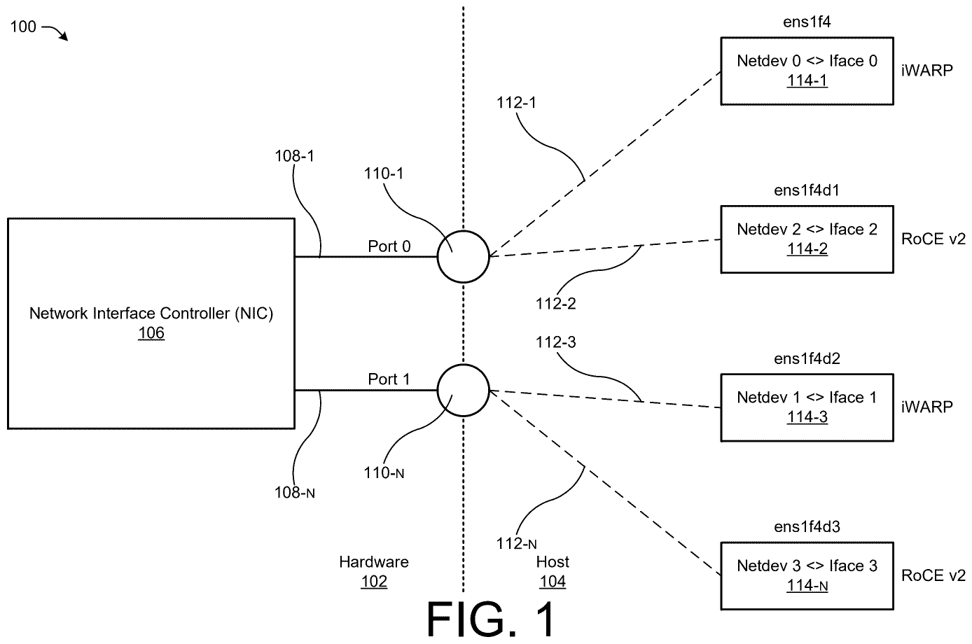

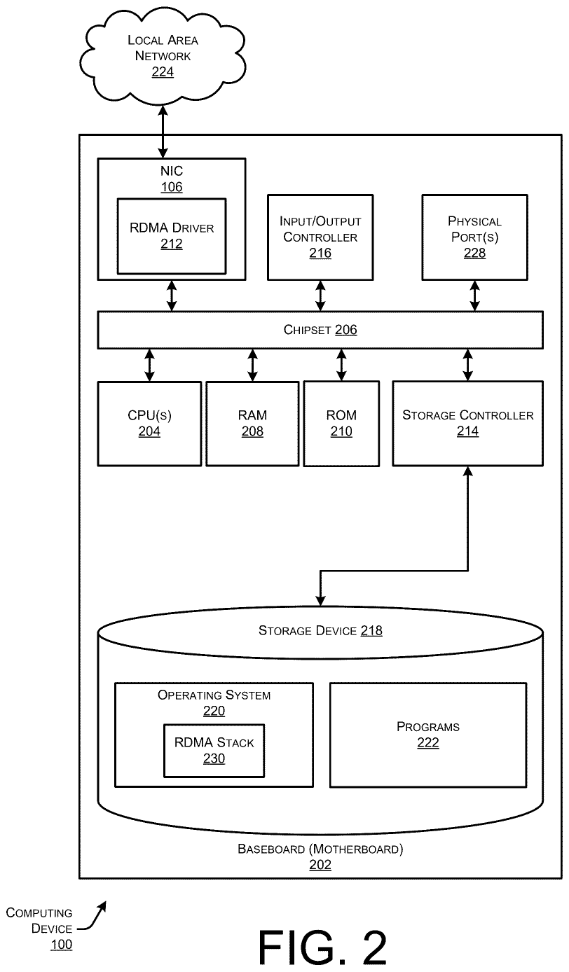

FIG. 1 illustrates communication hardware 102 of a computing device 100 (e.g., FIG. 2) including interfaces concurrently supporting different network protocols, according to an example of the principles described herein. The computing device may include any type of computing device such as, for example, a server computing device, a desktop computer, a laptop, and networking devices such as routers and switches, etc. The hardware 102 may include a network interface controller (NIC) 106. The NIC 106 may include any computer hardware component that connects a computer to a computer network. The NIC 106 may implement electronic circuitry required to communicate using a specific physical layer and data link layer standard such as Ethernet or Wi-Fi. This provides a base for a full network protocol stack, allowing communication among computers on the same computing network (e.g., a local area network (LAN)) and large-scale network communications through routable protocols, such as Internet protocol (IP). In one example, the NIC 106 may include a remote direct memory access (RDMA) enabled network interface controller which may be referred to herein as an RNIC. Further, although one NIC 106 is depicted in FIG. 1, a plurality of NICs 106 may be included within, for example, a server computing device where each of the ports of the plurality of NICs 106 may be connected to a router device.

The NIC 106 may be coupled to a host 104 portion of the computing device 100. The host 104 may be coupled to the hardware 102 via a number of communication lines 108-1, 108-N (where N is any integer greater than or equal to 1 (collectively referred to herein as communication line(s) 108 unless specifically addressed otherwise)). The communication lines 108 may couple the NIC 106 to a corresponding number of ports 110-1, 110-N (where N is any integer greater than or equal to 1 (collectively referred to herein as port(s) 110 unless specifically addressed otherwise)) (e.g., Port 0, Port 1, etc.). Although two ports 110 are depicted in FIG. 1, the NIC 106 may include any number of ports 110 including 1 or more ports 110. The ports 110 may include any hardware and/or software that provides for a connection to a network (e.g., a local area network (LAN) or wide area network (WAN)). The hardware (HW), RNIC, and software (SW) (HW/RNIC/SW) capability may be projected to expose two interfaces for each physical port 110. The ports 110 may be referred to as an Ethernet port or network port. The ports 110 may serve as the interface between the computing device 100 and the network, enabling data transmission and reception. The ports 110 may utilize physical cables (e.g., an Ethernet cable) to establish a physical connection. Further, the ports 110 may support various network protocols, such as TCP/IP, for communication. The ports 110 may be found as a standalone device or integrated into a motherboard of the computing device 100. The ports 110t provide the means for devices to access the Internet, share files, and communicate with other computing devices on the network. More specifically, a port 110 of the NIC 106 may include a hardware component that allows the computing device 100 to connect to a network and may be included in a desktop computer, a laptop, a server computing device, and networking devices such as routers and switches. The ports 110 of the NIC 106 serve as the interface between the host 104 and the network, enabling devices to connect to the host 104 of the computing device 100, communicate with the host 104, transfer data to and from the host 104, and access network resources of the host 104 efficiently.

The ports 110 may be designed to connect to an Ethernet cable, which in turn connects to network infrastructure. The ports 110 utilize the Ethernet protocol to transmit and receive data packets over the network and are responsible for handling the physical layer of the network communication, converting digital data into electrical signals that may be transmitted over the network cable, and vice versa.

In one example, the ports 110 of the NIC 106 may support any network speeds including speeds for high-bandwidth applications and data-intensive tasks and may include Gigabit Ethernet ports that provide data transfer rates of up to 1 gigabit per second (Gbps). Further, the ports 110 of the NICs 106 may support advanced features such as Power over Ethernet (PoE), which allows devices to receive power over the Ethernet cable, eliminating the need for separate power cables.

The ports 110 may create a plurality of interfaces as indicated by the interface communication lines 112-1, 112-2, 112-3, 112-N (where N is any integer greater than or equal to 1 (collectively referred to herein as interface communication line(s) 112 unless specifically addressed otherwise)) that couple the ports 110 to a corresponding number of interfaces 114-1, 114-2, 114-3, 114-N (where N is any integer greater than or equal to 1 (collectively referred to herein as interface(s) 114 unless specifically addressed otherwise)). The NIC 106 may expose these additional interfaces 114 for each physical port 110 to which the RoCEv2 device (e.g., the host 104) binds. The interfaces 114 may each appear to the host 104 as new ethernet interfaces with unique MAC addresses and IP addresses. In one example, the interfaces 114 may each be user configurable. FIG. 1 depicts the interfaces 114 were both of the ethernet interfaces are individually configurable and are independent of each other though they are tied to a single port 110 of the NIC 106 at the level of the hardware 102. The interfaces 114 may include an iWARP-based interface or a RoCEv2-based interface as described herein.

In order to provide concurrent iWARP and RoCEv2 protocol over the same physical port 110 of the NIC 106, the NIC 106 (e.g., via a NIC-specific RDMA driver) may register twice per port 110 with an RDMA stack. For example, the NIC 106 may register once as an iWARP port and a second time as an ROCEv2 port for each of the physical ports 110. This facilitates the overlying app to run iWARP and RoCEv2 simultaneously using the unique MAC addresses and IP addresses of the port 110. As depicted in FIG. 1, the interfaces 114 are designated as “ens1f4,” “ens1f4d1,” “ens1f4d2,” and “ens1f4d4,” respectively. As mentioned above, iWARP is a TCP-based protocol and RoCEv2 is a UDP-based protocol. Stated another way, the transport layer of iWARP is TCP-based and the transport layer for RoCEv2 is UDP-based.

The interfaces 114 are further designated using a plain ini-style text file such as “Netdev” that encodes configuration regarding a network device and may be used by a system service that manages the network of the computing device 100. Network device files have the extension .netdev. Network devices may be created as soon as networkd (a system daemon that manages network configuration) is started. If a netdev with a specified name already exists, networkd will use that existing name as-is rather than create its own, and the settings of a pre-existing netdev will not be changed by networkd. The . netdev files may be read from the files located in the system network directory (e.g., /lib/systemd/network), the volatile runtime network directory (e.g., /run/systemd/network) and the local administration network directory (e.g., /etc./systemd/network). Further, the interfaces 114 may further be associated with a command line utility such as “IP” that specifies a network interface. IP may be used in Linux to configure network interfaces such as the interfaces 114 and may be used with other parameters to specify the address family IP address, subnet mask, and default gateway. The IP utility may be used, for example, to obtain default network interfaces, obtain names of all network interfaces names available on the system, obtain network interface names with their respective MAC addresses, obtain network interface names with their respective IP addresses, and combinations thereof.

In FIG. 1, the pair of RoCEv2 interfaces 114 associated with the first port 110-1 include the first interface 114-1 which is executed under iWARP and the second interface 114-2 which is executed under RoCEv2. Similarly, the pair of RoCEv2 interfaces 114 associated with the second port 110-2 include the third RoCEv2 interface 114-3 which is executed under iWARP and the fourth or Nth interface 114-N which is executed under RoCEv2. In this manner, the RoCEv2 and iWarp interfaces 114 may provide concurrent iWARP and RoCEv2 protocol over the same physical port 110.

FIG. 2 illustrates a computer architecture diagram showing an illustrative computer hardware architecture for communicating over a physical port, according to an example of the principles described herein. The computer architecture depicted in FIG. 2 illustrates a server computer, a workstation, a desktop computer, a laptop computer, a tablet computing device, a network appliance, an e-reader, a smartphone, or other computing device, and may be utilized to execute any of the software components presented herein. The computing device 100 may, in one example, correspond to a physical server of a data center, a packet switching system, and/or the host 104 described herein with respect to FIG. 1.

The computing device 100 may include a baseboard 202, or “motherboard,” which is a printed circuit board to which a multitude of components or devices may be connected by way of a system bus or other electrical communication paths. In one example, one or more central processing units (“CPUs”) 204 operate in conjunction with a chipset 206. The CPU(s) 204 may be programmable processors that perform arithmetic and logical operations necessary for the operation of the computing device 100.

The CPU(s) 204 perform operations by transitioning from one discrete, physical state to the next through the manipulation of switching elements that differentiate between and change these states. Switching elements generally include electronic circuits that maintain one of two binary states, such as flip-flops, and electronic circuits that provide an output state based on the logical combination of the states of one or more other switching elements, such as logic gates. These basic switching elements may be combined to create more complex logic circuits, including registers, adders-subtractors, arithmetic logic units, floating-point units, and the like.

The chipset 206 provides an interface between the CPU(s) 204 and the remainder of the components and devices on the baseboard 202. The chipset 206 may provide an interface to a RAM 208, used as the main memory in the computing device 100. The chipset 206 may further provide an interface to a computer-readable storage medium such as a read-only memory (“ROM”) 210 or non-volatile RAM (“NVRAM”) for storing basic routines that help to start up the computing device 100 and to transfer information between the various components and devices. The ROM 210 or NVRAM may also store other software components necessary for the operation of the computing device 100 in accordance with the configurations described herein.

The computing device 100 may operate in a networked environment using logical connections to remote computing devices and computer systems through a network, such as the network 224 (e.g., a local area network (LAN)). The chipset 206 may include functionality for providing network connectivity through the NIC 106, such as a gigabit Ethernet adapter. The NIC 106 is capable of connecting the computing device 100 to other computing devices over the network 224. It should be appreciated that multiple NICs 106 may be present in the computing device 100, connecting the computer to other types of networks and remote computer systems.

The NIC 106 may include an RDMA driver 212. The RDMA driver 212 may include any RNIC-specific device driver to register the iWarp and RoCEv2 interfaces 114 with the RDMA software stack 230 as an iWARP-capable port and an RoCEv2-capable port, respectively. As describe herein, the RNIC-specific RDMA driver 212 may register twice per physical port 110 with the RDMA stack 230 such as, for example, one as an iWARP port and another as an ROCEv2 port. This facilitates the overlying app to run RoCEv2 and iWARP simultaneously using the unique IPs/MACs of the port 110.

The computing device 100 may be connected to a storage device 218 that provides non-volatile storage for the computing device 100. The storage device 218 may store an operating system 220, programs 222, and data, which have been described in greater detail herein. Further, the operating system 220 may include a remote direct memory access (RDMA) stack 230. Remote direct memory access (RDMA) is a technology that allows two networked computers to exchange data in their main memory without using the processor(s), cache(s), or operating system(s) of either computer. An RDMA stack 230 may be supported by a kernel driver stack, a userspace “provider” libraries, and/or Libibverbs, which provides an application program interface (API) for other control and data path operations.

The storage device 218 may be connected to the computing device 100 through a storage controller 214 connected to the chipset 206. The storage device 218 may consist of one or more physical storage units. The storage controller 214 may interface with the physical storage units through a serial attached SCSI (“SAS”) interface, a serial advanced technology attachment (“SATA”) interface, a fiber channel (“FC”) interface, or other type of interface for physically connecting and transferring data between computers and physical storage units.

The computing device 100 may store data on the storage device 218 by transforming the physical state of the physical storage units to reflect the information being stored. The specific transformation of physical state may depend on various factors, in different embodiments of this description. Examples of such factors may include, but are not limited to, the technology used to implement the physical storage units, whether the storage device 218 is characterized as primary or secondary storage, and the like.

For example, the computing device 100 may store information to the storage device 218 by issuing instructions through the storage controller 214 to alter the magnetic characteristics of a particular location within a magnetic disk drive unit, the reflective or refractive characteristics of a particular location in an optical storage unit, or the electrical characteristics of a particular capacitor, transistor, or other discrete component in a solid-state storage unit. Other transformations of physical media are possible without departing from the scope and spirit of the present description, with the foregoing examples provided only to facilitate this description. The computing device 100 may further read information from the storage device 218 by detecting the physical states or characteristics of one or more particular locations within the physical storage units.

In addition to the mass storage device 218 described above, the computing device 100 may have access to other computer-readable storage media to store and retrieve information, such as program modules, data structures, or other data. It should be appreciated by those skilled in the art that computer-readable storage media is any available media that provides for the non-transitory storage of data and that may be accessed by the computing device 100. In one example, the operations performed by the computing device 100, and or any components included therein, may be supported by one or more devices similar to computing device 100. Stated otherwise, some or all of the operations performed by the computing device 100, and or any components included therein, may be performed by one or more computing device 100 operating in any computing environment.

By way of example, and not limitation, computer-readable storage media may include volatile and non-volatile, removable and non-removable media implemented in any method or technology. Computer-readable storage media includes, but is not limited to, RAM, ROM, erasable programmable ROM (“EPROM”), electrically-erasable programmable ROM (“EEPROM”), flash memory or other solid-state memory technology, compact disc ROM (“CD-ROM”), digital versatile disk (“DVD”), high definition DVD (“HD-DVD”), BLU-RAY, or other optical storage, magnetic cassettes, magnetic tape, magnetic disk storage or other magnetic storage devices, or any other medium that may be used to store the desired information in a non-transitory fashion.

As mentioned briefly above, the storage device 218 may store an operating system 220 utilized to control the operation of the computing device 100. According to one embodiment, the operating system comprises the LINUX operating system. According to another embodiment, the operating system comprises the WINDOWS® SERVER operating system from MICROSOFT Corporation of Redmond, Washington. According to further embodiments, the operating system may comprise the UNIX operating system or one of its variants. It should be appreciated that other operating systems may also be utilized. The storage device 218 may store other system or application programs and data utilized by the computing device 100.

In one embodiment, the storage device 218 or other computer-readable storage media is encoded with computer-executable instructions which, when loaded into the computing device 100, transform the computer from a general-purpose computing system into a special-purpose computer capable of implementing the embodiments described herein. These computer-executable instructions transform the computing device 100 by specifying how the CPU(s) 204 transition between states, as described above. According to one embodiment, the computing device 100 has access to computer-readable storage media storing computer-executable instructions which, when executed by the computing device 100, perform the various processes described herein. The computing device 100 may also include computer-readable storage media having instructions stored thereupon for performing any of the other computer-implemented operations described herein.

The computing device 100 may also include one or more input/output controllers 216 for receiving and processing input from a number of input devices, such as a keyboard, a mouse, a touchpad, a touch screen, an electronic stylus, or other type of input device. Similarly, an input/output controller 216 may provide output to a display, such as a computer monitor, a flat panel display, a digital projector, a printer, or other type of output device. It will be appreciated that the computing device 100 might not include all of the components shown in FIG. 2, may include other components that are not explicitly shown in FIG. 2, or might utilize an architecture completely different than that shown in FIG. 2.

As described herein, networking and RDMA software architectures that do not employ the systems and methods described herein do not allow a user to run RoCEv2 and iWARP concurrently on same physical port of a RNIC/NIC. Therefore, the computing device 100 described herein in connection with FIGS. 1 and 2 and in the methods and systems described herein provide for the utilization of RoCEv2 and iWARP concurrently on same physical port 110 of the NIC 106 (e.g., RNIC). The methods and systems described herein allow for the exposing of the ports 110 to the RDMA stack 230 as being both RoCEv2 and iWARP capable. Further, the methods and systems described herein allow for the NIC 106 to expose two unique MAC addresses to the operating system 220 for each of its physical ports 110 that are independently monitorable and configurable.

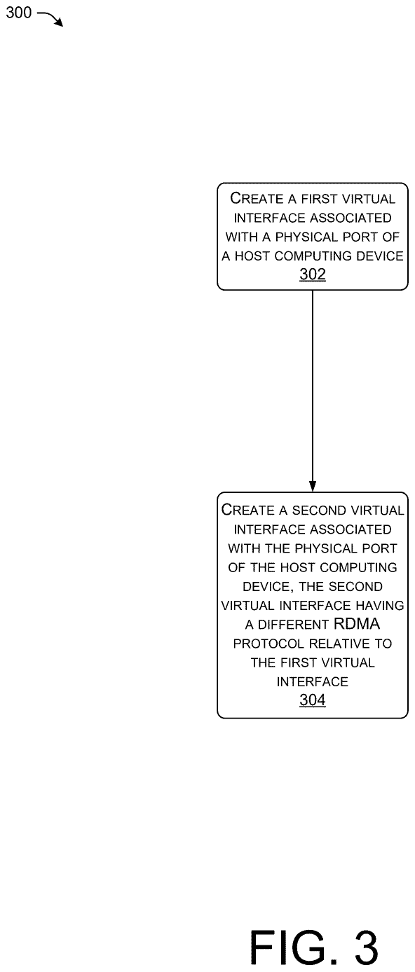

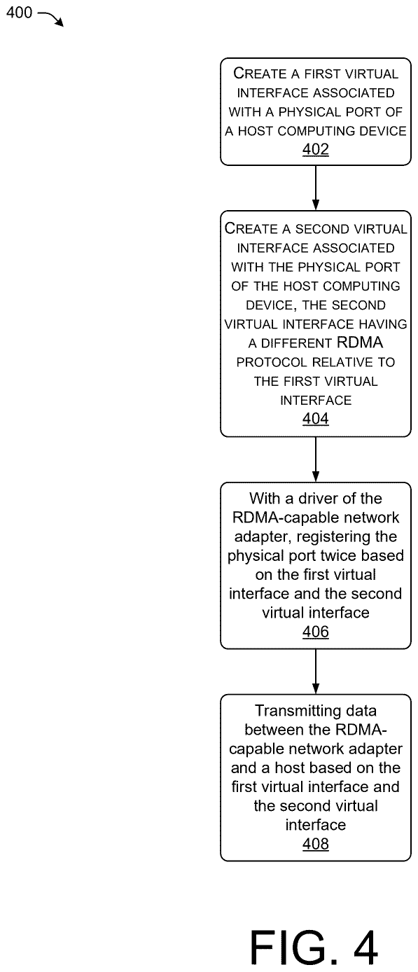

FIGS. 3 and 4 illustrate flow diagrams of example methods 300 and 400 and that illustrate aspects of the functions performed at least partly by the computing device 100 as described in FIGS. 1 and 2. The logical operations described herein with respect to FIGS. 3 and 4 may be implemented (1) as a sequence of computer-implemented acts or program modules running on a computing system and/or (2) as interconnected machine logic circuits or circuit modules within the computing system. In one example, the method(s) 300 and 400 may be performed by a system comprising one or more processors and one or more non-transitory computer-readable media storing computer-executable instructions that, when executed by the one or more processors, cause the one or more processors to perform the method(s) 300 and 400.

The implementation of the various components described herein is a matter of choice dependent on the performance and other requirements of the computing system. Accordingly, the logical operations described herein are referred to variously as operations, structural devices, acts, or modules. These operations, structural devices, acts, and modules may be implemented in software, in firmware, in special purpose digital logic, and any combination thereof. It should also be appreciated that more or fewer operations might be performed than shown in the FIGS. 3 and 4 and described herein. These operations may also be performed in parallel, or in a different order than those described herein. Some or all of these operations may also be performed by components other than those specifically identified. Although the techniques described in this disclosure is with reference to specific components, in other examples, the techniques may be implemented by less components, more components, different components, or any configuration of components.

FIG. 3 illustrates a flow diagram of an example method 300 for communicating over a physical port 110, according to an example of the principles described herein. The method 400 may include, at 402 and with the RDMA-capable NIC 106, creating a first iWARP-based or RoCEv2-based interface 114 (e.g., interface 114-1 or interface 114-3) associated with a physical port 110 (e.g., port 110-1 or port 110-N, respectively) of a host 104 of the computing device 100 and/or hardware 102 (e.g., the NIC 106) of the computing device 100. The method 400 may include, at 404 and with the RDMA-capable NIC 106, creating a second iWARP-based or RoCEv2-based interface 114 (e.g., interface 114-2 or interface 114-N) associated with a physical port 110 (e.g., port 110-1 or port 110-N, respectively) of a host 104 of the computing device 100 and/or hardware 102 (e.g., the NIC 106) of the computing device 100. The second interface 114 (e.g., interface 114-2 or interface 114-N) associated with a physical port 110 (e.g., port 110-1 or port 110-N, respectively) has a different RDMA protocol relative to the first interface 114 (e.g., interface 114-1 or interface 114-3) associated with a physical port 110 (e.g., port 110-1 or port 110-N, respectively). In the examples described herein, the different RDMA protocols of the first interface 114 (e.g., interface 114-1 or interface 114-3) and the second interface 114 (e.g., interface 114-2 or interface 114-N) may include the iWARP and RoCEv2 protocols.

FIG. 4 illustrates a flow diagram of an example method 400 for communicating over a physical port 110, according to an example of the principles described herein. The method 400 may include, at 402 and with the RDMA-capable NIC 106, creating a first interface 114 (e.g., interface 114-1 or interface 114-3) associated with a physical port 110 (e.g., port 110-1 or port 110-N, respectively) of a host 104 of the computing device 100 and/or hardware 102 (e.g., the NIC 106) of the computing device 100. The method 400 may include, at 404 and with the RDMA-capable NIC 106, creating a second interface 114 (e.g., interface 114-2 or interface 114-N) associated with a physical port 110 (e.g., port 110-1 or port 110-N, respectively) of a host 104 of the computing device 100 and/or hardware 102 (e.g., the NIC 106) of the computing device 100. The second interface 114 (e.g., interface 114-2 or interface 114-N) associated with a physical port 110 (e.g., port 110-1 or port 110-N, respectively) has a different RDMA protocol relative to the first interface 114 (e.g., interface 114-1 or interface 114-3) associated with a physical port 110 (e.g., port 110-1 or port 110-N, respectively). In the examples described herein, the different RDMA protocols of the first interface 114 (e.g., interface 114-1 or interface 114-3) and the second interface 114 (e.g., interface 114-2 or interface 114-N) may include iWARP and RoCEv2 protocol.

At 406, the method 400 may further include, with a driver (e.g., the RDMA driver 212) of the RDMA-capable network adapter (e.g., the NIC 106), registering the physical port 110 twice based on the first interface 114 (e.g., interface 114-1 or interface 114-3) and the second interface 114 (e.g., interface 114-2 or interface 114-N). For example, the port 110 may be registered in a first instance for iWARP and concurrently in a second instance for RoCEv2 protocol. Although iWARP and RoCEv2 protocol are used as examples as the different RDMA protocols, any RDMA protocols may be used as the different RDMA protocols.

Further, the method 400 may include, at 408, transmitting data between the RDMA-capable network adapter (e.g., the NIC 106) and the host 104 based on the first interface 114 (e.g., interface 114-1 or interface 114-3) and the second interface 114 (e.g., interface 114-2 or interface 114-N). This includes transmitting data between the RDMA-capable network adapter (e.g., the NIC 106) and the host 104 utilizing the RDMA protocols of the particular interface 114 that utilizes the requisite or desired RDMA protocol (e.g., iWARP and RoCEv2 protocol).

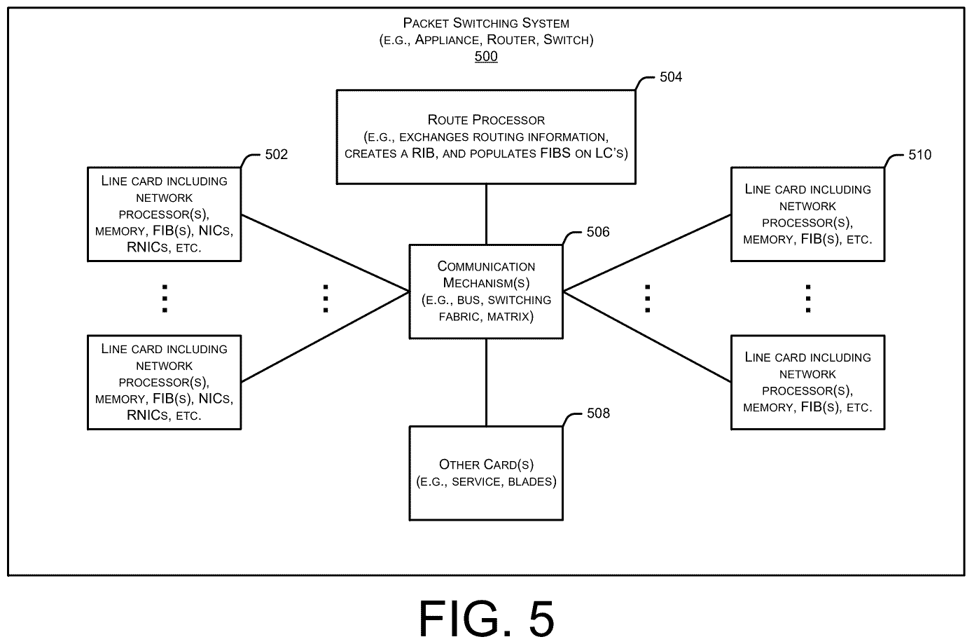

FIG. 5 illustrates a block diagram illustrating an example packet switching device (or system) 500, according to an example of the principles described herein. The packet switching device 500 of FIG. 5 may be utilized to implement various aspects of the technologies disclosed herein. In one example, packet switching device 500 may be employed in various networks, such as, for example, the network in which the computing device 100 of FIG. 1 operates and/or the network 224 (e.g., the LAN) of FIG. 2.

In one example, the packet switching device 500 may comprise multiple line card(s) 502, 510, each with one or more network interfaces for sending and receiving packets over communications links (e.g., possibly part of a link aggregation group). The packet switching device 500 may also have a control plane with one or more processing elements 504 for managing the control plane and/or control plane processing of packets associated with forwarding of packets in a network. The packet switching device 500 may also include other cards 508 (e.g., service cards, blades) which include processing elements that are used to process (e.g., forward/send, drop, manipulate, change, modify, receive, create, duplicate, apply a service) packets associated with forwarding of packets in a network. The packet switching device 500 may comprise hardware-based communication mechanism 506 (e.g., bus, switching fabric, and/or matrix, etc.) for allowing its different entities 502, 504, 508 and 510 to communicate. Line card(s) 502, 510 may typically perform the actions of being both an ingress and/or an egress line card 502, 510, in regard to multiple other particular packets and/or packet streams being received by, or sent from, packet switching device 500.

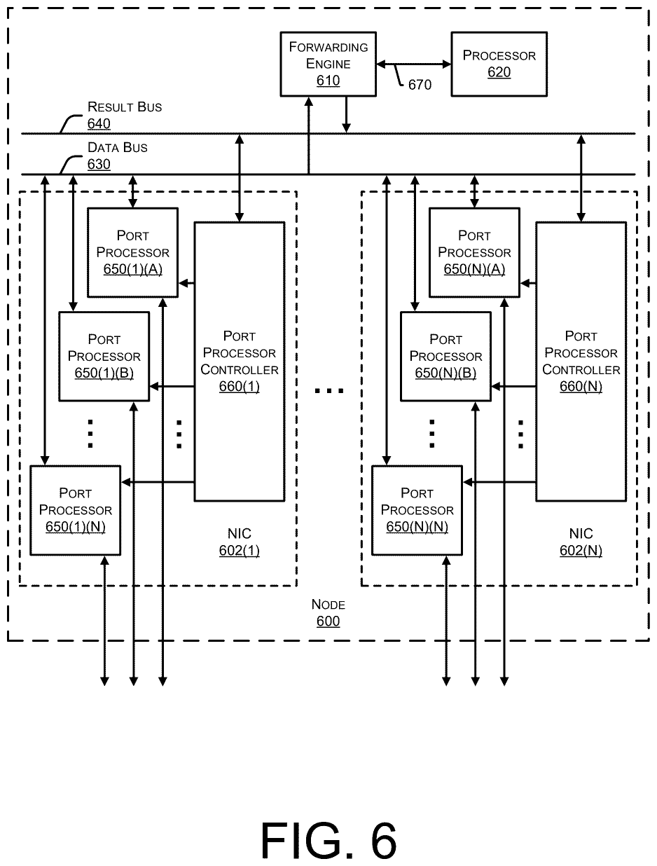

FIG. 6 illustrates a block diagram illustrating certain components of an example node 600, according to an example of the principles described herein. The node 600 of FIG. 6 may be utilized to implement various aspects of the technologies disclosed herein. In one example, node(s) 600 may be employed in various networks, such as, for example, the network in which the computing device 100 of FIG. 1 operates and/or the network 224 (e.g., the LAN) of FIG. 2.

In one example, the node 600 may include any number of NICs 602 (e.g., NICs 602(1)-(N), where N may be any integer greater than 1) that are communicatively coupled to a forwarding engine 610 (also referred to as a packet forwarder) and/or a processor 620 via a data bus 630 and/or a result bus 640. The NICs 602 may be any NIC including an RNIC. NICs 602(1)-(N) may include any number of port processors 650(1)(A)-(N)(N) which are controlled by port processor controllers 660(1)-(N), where N may be any integer greater than 1. Additionally, or alternatively, forwarding engine 610 and/or processor 620 are not only coupled to one another via the data bus 630 and the result bus 640, but may also communicatively coupled to one another by a communications link 670.

The processors (e.g., the port processor(s) 650 and/or the port processor controller(s) 660) of each NIC 602 may be mounted on a single printed circuit board. When a packet or packet and header are received, the packet or packet and header may be identified and analyzed by node 600 (also referred to herein as a router) in the following manner. Upon receipt, a packet (or some or all of its control information) or packet and header may be sent from one of port processor(s) 650(1)(A)-(N)(N) at which the packet or packet and header was received and to one or more of those devices coupled to the data bus 630 (e.g., others of the port processor(s) 650(1)(A)-(N)(N), the forwarding engine 610 and/or the processor 620). Handling of the packet or packet and header may be determined, for example, by the forwarding engine 610. For example, the forwarding engine 610 may determine that the packet or packet and header should be forwarded to one or more of port processors 650(1)(A)-(N)(N). This may be accomplished by indicating to corresponding one(s) of port processor controllers 660(1)-(N) that the copy of the packet or packet and header held in the given one(s) of port processor(s) 650(1)(A)-(N)(N) should be forwarded to the appropriate one of port processor(s) 650(1)(A)-(N) (N). Additionally, or alternatively, once a packet or packet and header has been identified for processing, the forwarding engine 610, the processor 620, and/or the like may be used to process the packet or packet and header in some manner and/or maty add packet security information in order to secure the packet. On a node 600 sourcing such a packet or packet and header, this processing may include, for example, encryption of some or all of the information of the packet or the packet and header, the addition of a digital signature, and/or some other information and/or processing capable of securing the packet or packet and header. On a node 600 receiving such a processed packet or packet and header, the corresponding process may be performed to recover or validate the information of the packet or packet and header that has been secured.

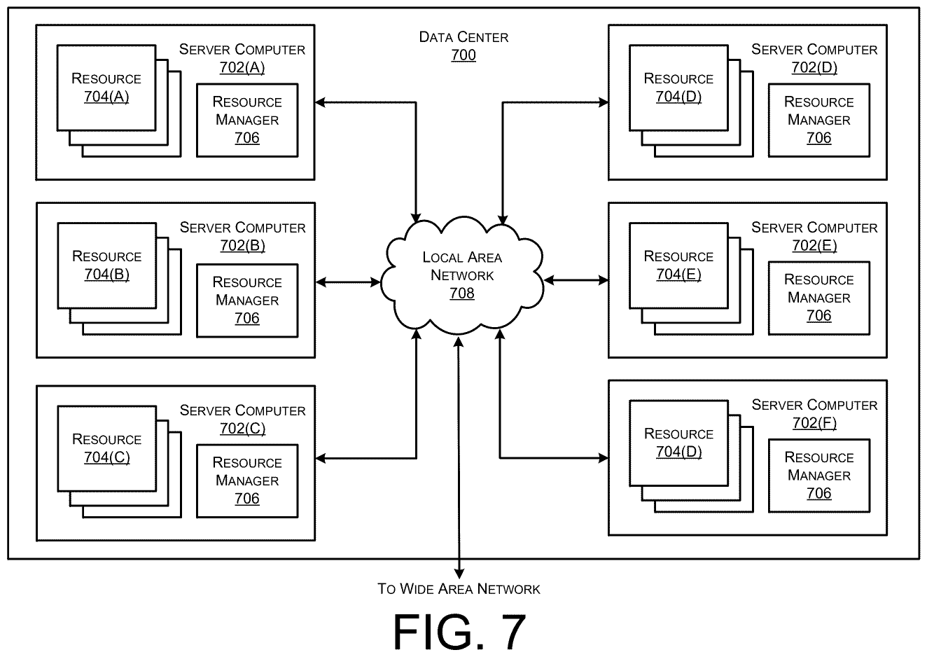

FIG. 7 illustrates a computing system diagram illustrating a configuration for a data center 700, according to an example of the principles described herein. The data center 700 of FIG. 7 may be utilized to implement aspects of the technologies disclosed herein. The example data center 700 shown in FIG. 7 includes several server computers 702A-702F (which might be referred to herein singularly as “a computing device 100” or in the plural as “the server computers 702”) for providing computing resources. In one example, the resources and/or server computers 702 may include, or correspond to, any type of networked device described herein. Although described as servers, the server computers 702 may comprise any type of networked device, such as servers, switches, routers, hubs, bridges, gateways, modems, repeaters, access points, etc.

The server computers 702 may be standard tower, rackmount, or blade server computers configured appropriately for providing computing resources. In one example, the server computers 702 may provide computing resources 704 including data processing resources such as hardware computing systems, database clusters, computing clusters, storage clusters, data storage resources, database resources, networking resources,, and others. Some of the server computers 702 may also be configured to execute a resource manager 706 capable of instantiating and/or managing the computing resources. In the case of VM instances, for example, the resource manager 706 may be a hypervisor or another type of program configured to enable the execution of multiple VM instances on a single computing device 100. Server computers 702 in the data center 700 may also be configured to provide network services and other types of services.

In the example data center 700 shown in FIG. 7, an appropriate LAN 708 is also utilized to interconnect the server computers 702A-702F. It may be appreciated that the configuration and network topology described herein has been greatly simplified and that many more computing systems, software components, networks, and networking devices may be utilized to interconnect the various computing systems disclosed herein and to provide the functionality described above. Appropriate load balancing devices or other types of network infrastructure components may also be utilized for balancing a load between data centers 700, between each of the server computers 702A-702F in each data center 700, and, potentially, between computing resources in each of the server computers 702. It may be appreciated that the configuration of the data center 700 described with reference to FIG. 7 is merely illustrative and that other implementations may be utilized.

In one example, the server computers 702 and or the computing resources 704 may each execute/host one or more tenant containers to perform techniques described herein.

In one example, the data center 700 may provide computing resources such as, for example, tenant containers and storage, on a permanent or an as-needed basis. Among other types of functionalities, the computing resources provided by a cloud computing network may be utilized to implement the various services and techniques described herein. The computing resources 704 provided by the cloud computing network may include various types of computing resources, such as data processing resources like tenant containers, data storage resources, networking resources, data communication resources, network services, and the like.

Each type of computing resource 704 provided by the cloud computing network may be general-purpose or may be available in a number of specific configurations. For example, data processing resources may be available as physical computers or VM instances in a number of different configurations. The VM instances may be configured to execute applications, including web servers, application servers, media servers, database servers, some or all of the network services described above, and/or other types of programs. Data storage resources may include file storage devices, block storage devices, and the like. The cloud computing network may also be configured to provide other types of computing resources 704 not mentioned specifically herein.

The computing resources 704 provided by a cloud computing network may be enabled in one example by one or more data centers 700 (which might be referred to herein singularly as “a data center 700” or in the plural as “the data centers 700”). The data centers 700 are facilities utilized to house and operate computer systems and associated components. The data centers 700 typically include redundant and backup power, communications, cooling, and security systems. The data centers 700 may also be located in geographically disparate locations. One illustrative example for a data center 700 that may be utilized to implement the technologies disclosed herein is described herein with regard to, for example, FIGS. 1 through 6.

While the invention is described with respect to the specific examples, it is to be understood that the scope of the invention is not limited to these specific examples. Since other modifications and changes varied to fit particular operating requirements and environments will be apparent to those skilled in the art, the invention is not considered limited to the example chosen for purposes of disclosure and covers all changes and modifications which do not constitute departures from the true spirit and scope of this invention.

Although the application describes embodiments having specific structural features and/or methodological acts, it is to be understood that the claims are not necessarily limited to the specific features or acts described. Rather, the specific features and acts are merely illustrative some embodiments that fall within the scope of the claims of the application.

### CONCLUSION

The examples described herein provide systems and methods for communicating over a physical port 110 including a Remote Direct Memory Access (RDMA) capable network adapter, a host computing device communicatively coupled to the RDMA capable network adapter, a physical port associated with the host computing device, and a plurality of interfaces associated with the physical port, the plurality of interfaces having different RDMA protocols. As described herein, networking and RDMA software architectures that do not employ the systems and methods described herein do not allow a user to run RoCEv2 and iWARP concurrently on same physical port of a RNIC/NIC. Therefore, the computing device 100 described herein in connection with FIGS. 1 and 2 and in the methods and systems described herein provide for the utilization of RoCEv2 and iWARP concurrently on same physical port 110 of the NIC 106 (e.g., RNIC). The methods and systems described herein allow for the exposing of the ports 110 to the RDMA stack 230 as being both RoCEv2 and iWARP capable. Further, the methods and systems described herein allow for the NIC 106 to expose two unique MAC addresses to the operating system 220 for each of its physical ports 110 that are independently monitorable and configurable.

While the present systems and methods are described with respect to the specific examples, it is to be understood that the scope of the present systems and methods are not limited to these specific examples. Since other modifications and changes varied to fit particular operating requirements and environments will be apparent to those skilled in the art, the present systems and methods are not considered limited to the example chosen for purposes of disclosure and covers all changes and modifications which do not constitute departures from the true spirit and scope of the present systems and methods.

Although the application describes examples having specific structural features and/or methodological acts, it is to be understood that the claims are not necessarily limited to the specific features or acts described. Rather, the specific features and acts are merely illustrative of some examples that fall within the scope of the claims of the application.

What is claimed is:

1. A system for communicating over a physical port, comprising:
a Remote Direct Memory Access (RDMA) capable network adapter;
a host computing device communicatively coupled to the RDMA capable network adapter;
a physical port associated with the host computing device; and
a plurality of interfaces associated with the physical port, the plurality of interfaces having different RDMA protocols.

2. The system of claim 1, wherein the plurality of interfaces appear to the host computing device as ethernet interfaces with unique medium access control (MAC) addresses and internet protocol (IP) addresses.

3. The system of claim 1, wherein the plurality of interfaces are individually configurable.

4. The system of claim 1, wherein the plurality of interfaces associated with the physical port are independent of each other.

5. The system of claim 1, wherein the different RDMA protocols comprise internet wide area RDMA protocol (iWARP) and RDMA over converged Ethernet version 2 (RoCEv2) protocol.

6. The system of claim 1, wherein the different RDMA protocols are executed concurrently over the physical port of the RDMA capable network adapter.

7. The system of claim 1, wherein the physical port comprises a plurality of physical ports.

8. A non-transitory computer-readable medium storing instructions that, when executed, causes a processor to perform operations, comprising:
with a Remote Direct Memory Access (RDMA) capable network adapter:
creating a first interface associated with a physical port of a host computing device; and
creating a second interface associated with the physical port of the host computing device, the second interface having a different RDMA protocol relative to the first interface.

9. The non-transitory computer-readable medium of claim 8, the operations further comprising, with a driver of the RDMA capable network adapter, registering the physical port twice based on the first interface and the second interface.

10. The non-transitory computer-readable medium of claim 8, wherein the different RDMA protocols of the first interface and the second interface comprise internet wide area RDMA protocol (iWARP) and RDMA over converged Ethernet version 2 (RoCEv2) protocol, respectively.

11. The non-transitory computer-readable medium of claim 8, wherein the first interface and the second interface appear to a host computing device as ethernet interfaces with unique medium access control (MAC) addresses and internet protocol (IP) addresses.

12. The non-transitory computer-readable medium of claim 8, wherein the first interface and the second interface are individually configurable.

13. The non-transitory computer-readable medium of claim 8, wherein the first interface and the second interface are independent of each other.

14. The non-transitory computer-readable medium of claim 8, wherein the different RDMA protocols are executed concurrently over the physical port of the RDMA capable network adapter.

15. The non-transitory computer-readable medium of claim 8, wherein the physical port comprises a plurality of physical ports.

16. A method of communicating over a physical port, comprising:
with a Remote Direct Memory Access (RDMA) capable network adapter:
creating a first interface associated with a physical port of a host computing device; and
creating a second interface associated with the physical port of the host computing device, the second interface having a different RDMA protocol relative to the first interface.

17. The method of claim 16, further comprising, with a driver of the RDMA capable network adapter, registering the physical port twice based on the first interface and the second interface.

18. The method of claim 16, wherein:
the different RDMA protocols of the first interface and the second interface comprise internet wide area RDMA protocol (iWARP) and RDMA over converged Ethernet version 2 (RoCEv2) protocol, respectively; and
the first interface and the second interface appear to a host computing device as ethernet interfaces with unique medium access control (MAC) addresses and internet protocol (IP) addresses.

19. The method of claim 16, wherein:
the first interface and the second interface are individually configurable; and
the first interface and the second interface are independent of each other.

20. The method of claim 16, wherein the different RDMA protocols are executed concurrently over the physical port of the RDMA capable network adapter.
